(19) United States
(12) Patent Application Publication
(10) Pub. No.: US 2018/0278667 A1
(43) Pub. Date: Sep. 27, 2018

(54) MULTIMEDIA DATA TRANSMISSION SYSTEM AND MULTIMEDIA DATA TRANSMISSION METHOD

(71) Applicant: AVerMedia TECHNOLOGIES, INC., New Taipei City (TW)

(72) Inventor: Ming-Chang WANG, New Taipei City (TW)

(21) Appl. No.: 15/921,656

(22) Filed: Mar. 15, 2018

(30) Foreign Application Priority Data
Mar. 24, 2017 (TW) 106110021

(51) Int. Cl. H04L 29/06; H04L 12/26

(52) U.S. Cl. CPC H04L 65/605; H04L 43/16; H04L 43/0882

(57) ABSTRACT

A multimedia data transmission method includes the following procedures: outputting multimedia data; detecting a transmission bandwidth when transmitting the multimedia data; determining whether the transmission bandwidth is larger than a bandwidth threshold or not; inserting a plurality of meaningless packets in the multimedia data if the transmission bandwidth is larger than the bandwidth threshold; and decreasing a number of the meaningless packets and increasing a quality of the multimedia data if the number of the meaningless packets is larger than a number threshold.

### CROSS-REFERENCE TO RELATED APPLICATION

This application claims the priority benefit of TAIWAN Application serial no. 106110021, filed March 24, 2017, the full disclosure of which is incorporated herein by reference.

### FIELD OF INVENTION

The invention relates to a multimedia data transmission method and a multimedia data transmission system. More particularly, the invention relates to a multimedia data transmission method and a multimedia data transmission system for dynamically adjusting a transmission amount of multimedia data in response to transmission bandwidth.

### BACKGROUND

At present, the direct dialing software on the market may have abnormal or unstable video quality when the network bandwidth is unstable, which causes inconvenience to the user in watching multimedia data. In addition, when the network bandwidth is unstable, issues regarding audio and video data being discarded, or the fluency of video playback being reduced may occur.

Therefore, how to adjust the most suitable multimedia data transmission amount according to the change of the network bandwidth without affecting the smooth playback of the multimedia data while the multimedia data is playing instantaneously, and how to prevent the multimedia data from being discarded when adjusting the multimedia data transmission amount and how to gradually restore the bandwidth of multimedia data transmission capacity to the original set value, are the problems needed to be addressed in the art.

### SUMMARY

An aspect of this disclosure is to provide a multimedia data transmission method. The multimedia data transmission method includes the following procedures: outputting multimedia data; detecting a transmission bandwidth when transmitting the multimedia data; determining whether the transmission bandwidth is larger than a bandwidth threshold or not; inserting a plurality of meaningless packets in the multimedia data if the transmission bandwidth is larger than the bandwidth threshold; and decreasing a number of the meaningless packets and increasing a quality of the multimedia data if the number of the meaningless packets is larger than a number threshold.

Another aspect of this disclosure is to provide a multimedia data transmission system. The multimedia data transmission system includes a multimedia processing device, a register, an internet transmission device, and a dynamic adjustment device. The multimedia processing device is configured to output multimedia data. The register is coupled to the multimedia processing device, in which the register is configured to temporarily store a plurality of data packets of the multimedia data. The internet transmission device is coupled to the register, in which the internet transmission device is configured to transmit the data packets. The dynamic adjustment device is configured to detect a transmission bandwidth of the internet transmission device, and configured to determine whether the transmission bandwidth is larger than a bandwidth threshold or not. When the dynamic adjustment device determines the transmission bandwidth is larger than the bandwidth threshold, at least one of the multimedia processing device, the register and the internet transmission device inserts a plurality of meaningless packets in the multimedia data, and if the number of the meaningless packets is larger than a number threshold, at least one of the multimedia processing device, the register and the internet transmission device decreases the number of the meaningless packets, and the multimedia processing device increases a quality of the multimedia data.

Another aspect of this disclosure is to provide a multimedia data transmission method. The multimedia data transmission method includes the following procedures: outputting multimedia data, wherein the multimedia data comprises a plurality of data packets, and the data packets comprises a plurality of meaningless packet; detecting a transmission bandwidth when transmitting the multimedia data; determining whether the transmission bandwidth is smaller than a bandwidth threshold or not; and decreasing the number of the meaningless packets if the transmission bandwidth is smaller than the bandwidth threshold.

Another aspect of this disclosure is to provide a multimedia data transmission system. The multimedia data transmission system includes a multimedia processing device, a register, an internet transmission device, and a dynamic adjustment device. The multimedia processing device is configured to output multimedia data, in which the multimedia data comprises a plurality of data packets, and the data packets comprises a plurality of meaningless packet. The register is coupled to the multimedia processing device, in which the register temporarily stores the data packets of the multimedia data. The internet transmission device is coupled to the register, in which the internet transmission device is configured to transmit the data packets. The dynamic adjustment device is configured to detect a transmission bandwidth of the internet transmission device, and determine whether the transmission bandwidth is smaller than a bandwidth threshold or not. When the dynamic adjustment device determines the transmission bandwidth is smaller than the bandwidth threshold, at least one of the multimedia processing device, the register and the internet transmission device decreases the number of the meaningless packets.

Therefore, according to the technical concept of the present invention, embodiments of this disclosure are to provide a multimedia data transmission method and a multimedia data transmission system, and in particular, a multimedia data transmission method and a multimedia data transmission system for dynamically adjusting a transmission amount of multimedia data in response to transmission bandwidth, so as to effectively avoid multimedia data being discarded due to the lack of bandwidth, and in the case of sufficient bandwidth, the original compressed multimedia data may be gradually restored to the original settings. In this way, the most appropriate multimedia data transfer amount may be adjusted according to changes in network bandwidth without affecting the fluency of the video and multimedia data playback.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic diagram illustrating a multimedia data transmission system according to some embodiments of the present disclosure.

FIG. 1B is a schematic diagram illustrating another multimedia data transmission system according to some embodiments of the present disclosure.

FIG. 1C is a schematic diagram illustrating another multimedia data transmission system according to some embodiments of the present disclosure.

FIG. 2 is a flow chart illustrating a multimedia data transmission method according to some embodiments of the present disclosure.

FIG. 3 is a flow chart illustrating another multimedia data transmission method according to some embodiments of the present disclosure.

FIG. 4 is a flow chart illustrating another multimedia data transmission method according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

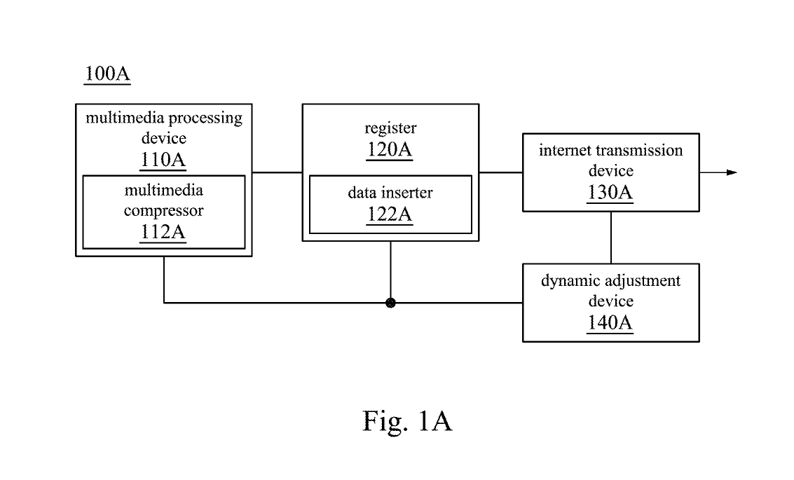

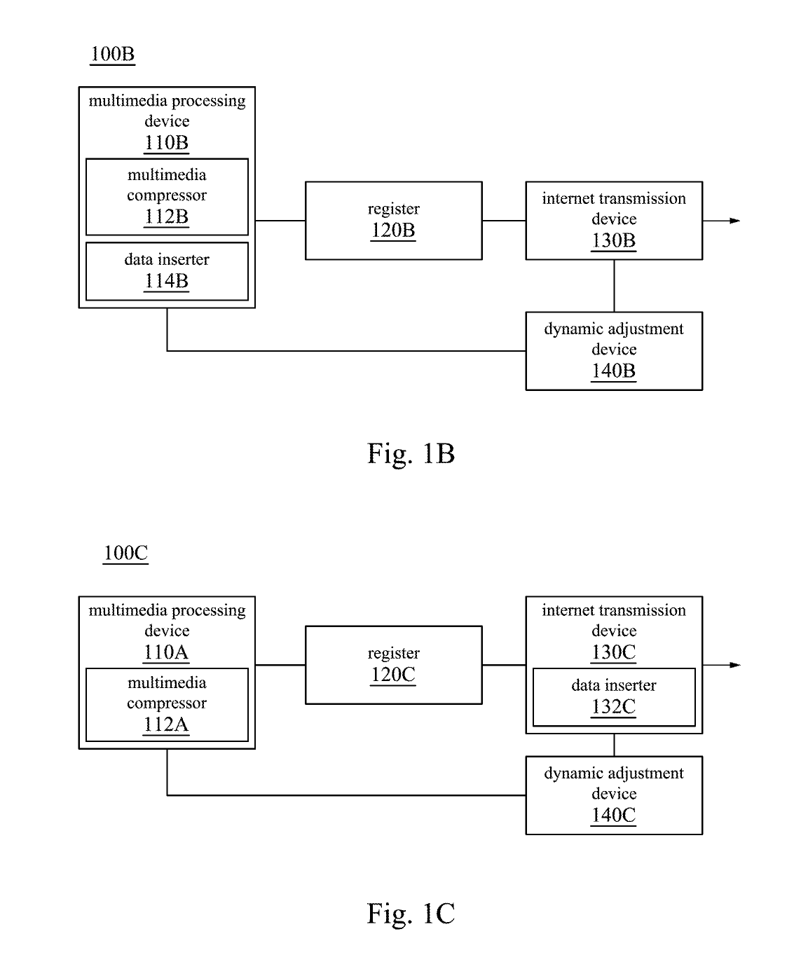

FIG. 1A is a schematic diagram illustrating a multimedia data transmission system according to some embodiments of the present disclosure. The multimedia data transmission system 100A includes multimedia processing device 110A, a register 120A, an internet transmission device 130A and a dynamic adjustment device 140A. Furthermore, the multimedia processing device 110A includes multimedia compressor 112A, and the register 120A includes a data inserter 122A. The above-mentioned register 120A couples to the multimedia processing device 110A and an internet transmission device 130A, and the dynamic adjustment device 140A couples to the multimedia processing device 110A, the internet transmission device 130A and the register 120A.

The multimedia processing device 110A outputs multimedia data to the register 120A, the register 120A further transmits the multimedia data to the internet transmission device 130A. Then the internet transmission device 130A further transmits the data to the client side or the server side. If the internet transmission device 130A is not able to transmit all of the multimedia data transmitted from the multimedia processing device 110A to the client side or the server side, the packets of the multimedia data may be temporarily stored in the register 120A.

In some embodiments of the present disclosure, when outputting the multimedia data, the multimedia processing device 110A presets the bandwidth threshold when transmitting the multimedia data. In some embodiments of the present disclosure, the bandwidth threshold may be set by the dynamic adjustment device 140A, or set the bandwidth threshold through the dynamic adjustment device 140A and/or the multimedia processing device 110A by the user.

The above-mentioned bandwidth threshold is the bandwidth that playback the multimedia data. For example, when the multimedia data video display format is 1080p, multimedia processing device 110A sets the bandwidth threshold to be 10M bit rates (10 Mbps), and when the multimedia data video display format is 720p, multimedia processing device 110A sets the bandwidth threshold to be 5M bit rates (5 Mbps). In response to resolution, frame rate, and bit rate of different multimedia data, different bandwidth threshold may be set. The above-mentioned bandwidth threshold and video display format are for illustrative purposes only, and the present disclosure is not limited to this.

The above-mentioned dynamic adjustment device 140A detects the transmission bandwidth of the internet transmission device 130A. The above-mentioned transmission bandwidth may dynamically change along with time, hardware and/or other user's usage behavior.

The dynamic adjustment device 140A determines whether the transmission bandwidth is larger than the bandwidth threshold or not. For example, if the transmission bandwidth is 6 Mbps, and the bandwidth threshold is 5 Mbps, the dynamic adjustment device 140A determines that the transmission bandwidth is larger than the bandwidth threshold. On the other hand, if the transmission bandwidth is 5 Mbps, and the bandwidth threshold is 6 Mbps, the dynamic adjustment device 140A determines that the transmission bandwidth is not larger than the bandwidth threshold.

When the dynamic adjustment device 140A determines that the transmission bandwidth is larger than the bandwidth threshold, the register 120A and/or the data inserter 122A insert several meaningless packets in the multimedia data. The above-mentioned meaningless packets may be blank packets, wrong packets, and/or undefined packets. For example, if the transmission bandwidth is 6 Mbps, and the bandwidth threshold is 5 Mbps, the dynamic adjustment device 140A determines that the transmission bandwidth is larger than the bandwidth threshold, and the register 120A and/or the data inserter 122A may insert meaningless packets in the multimedia data. The above-mentioned number of the meaningless packets may be for example, 1 Mbps.

In some embodiments of the present disclosure, when the number of the meaningless packets is larger than the number threshold, the dynamic adjustment device 140A controls the register 120A and/or the data inserter 122A to decrease the number of the meaningless packets according to the transmission bandwidth. For example, if the number threshold is 5 Mbps, when the number of the meaningless packets is larger than 5 Mbps, the dynamic adjustment device 140A controls the register 120A and/or the data inserter 122A to decrease the number of the meaningless packets according to the transmission bandwidth.

When the number of the meaningless packets is larger than the number threshold, the register 120A and/or the data inserter 122A decreases the number of the meaningless packets, and the multimedia processing device 110A increases the quality of the multimedia data. For example, if the number threshold is 5 Mbps, and when the number of the meaningless packets is larger than 5 Mbps, the register 120A and/or the data inserter 122A decreases the number of the meaningless packets, and the multimedia processing device 110A increases the quality of the multimedia data. For example, adjust the multimedia data from 720p to 1080p. In some embodiments of the present disclosure, the multimedia processing device 110A increase the quality of the multimedia data by increasing at least one of the resolutions, frame rate, and bit rate of the multimedia data.

In some embodiments of the present disclosure, when the number of the meaningless packets is larger than the number threshold, the dynamic adjustment device 140A controls the multimedia processing device 112A to adjust the resolution, the frame rate and/or the bit rate of the multimedia data according to the transmission bandwidth. For example, if the number threshold is 5 Mbps, when the number of the meaningless packets is larger than 5 Mbps, the register 120A and/or the data inserter 122A may decrease the number of the meaningless packets, and the dynamic adjustment device 140A controls the multimedia processing device 110A to adjust the resolution, the frame rate and/or the bit rate of the multimedia data according to the transmission bandwidth. For example, the dynamic adjustment device 140A controls the multimedia processing device 110A to adjust the multimedia data from 720p to 1080p according to the transmission bandwidth. In some embodiments of the present disclosure, the multimedia processing device 110A adjust the resolution, frame rate and/or bit rate of the multimedia data by the multimedia compressor 112A.

In some embodiments of the present disclosure, the multimedia data transmitted is increased sequentially. For example, the multimedia data transmitted may be increased sequentially from 5 Mbps to 6 Mbps, and then from 6 Mbps to 7 Mbps, according to the number of the meaningless packets, so as to ensure smooth playback of multimedia data.

In some embodiments of the present disclosure, when the number of the meaningless packets is larger than number threshold, the data inserter 122A of the register 120A decrease the number of the meaningless packets, the multimedia processing device 110A increases the quality of the multimedia data, and the dynamic adjustment device 140A and/or the multimedia processing device 110A increases the bandwidth threshold. For example, if the number threshold is 5 Mbps, when the number of the meaningless packets is larger than 5 Mbps, the register 120A and/or the data inserter 122A decreases the number of the meaningless packets from 5 Mbps to 0 Mbps, the dynamic adjustment device 140A controls the multimedia processing device 110A to adjust the multimedia data from 720p to 1080p according to the transmission bandwidth, and the dynamic adjustment device 140A and/or the multimedia processing device 110A increases the bandwidth threshold from 5 Mbps to 10 Mbps. The above-mentioned number threshold and the video display format are for illustrative purposes only, and the present disclosure is not limited to this.

In some embodiments of the present disclosure, when the number of the meaningless packets is larger than number threshold, the register 120A and/or the data inserter 122A decreases the number of the meaningless packets, the multimedia processing device 110A increases the quality of the multimedia data, and the dynamic adjustment device 140A and/or the multimedia processing device 110A increases the bandwidth threshold, in which the increment of the bandwidth threshold is equal to the decrement of the meaningless packet. For example, if the number threshold is 5 Mbps, when the number of the meaningless packets is larger than 5 Mbps, the dynamic adjustment device 140A controls the multimedia processing device 110A and/or the multimedia compressor 112A to adjust the multimedia data from 720p into 1080p according to the transmission bandwidth, the register 120A and/or the data inserter 122A decreases 5 Mbps of the meaningless packets, and the dynamic adjustment device 140A and/or the multimedia processing device 110A increases the bandwidth threshold from 5 Mbps to 10 Mbps. That is, the increment of the bandwidth threshold is equal to the decrement of the meaningless packets.

Reference is made to FIG. 1 again. In some other embodiments of the present disclosure, the multimedia data transmission system 110A outputs the multimedia data, the above-mentioned multimedia data includes several data packets, and the data packets includes several meaningless packets. When the dynamic adjustment device 140A determines that the transmission bandwidth is smaller than the bandwidth threshold, the register 120A and/or the data inserter 122A decreases the number of the meaningless packets. For example, if the transmission bandwidth is 8 Mbps and the bandwidth threshold is 10 Mbps, when the dynamic adjustment device 140A determines that the transmission bandwidth is smaller than the bandwidth threshold, the register 120A and/or the data inserter 122A decreases the number of the meaningless packets.

In some embodiments of the present disclosure, when the dynamic adjustment device 140A determines that transmission bandwidth is smaller than the bandwidth threshold, the dynamic adjustment device 140A controls the register 120A and/or the data inserter 122A to decrease the number of the meaningless packets according to the transmission bandwidth. For example, if the transmission bandwidth is 5 Mbps, and the bandwidth threshold is 7 Mbps, the dynamic adjustment device 140A determines that the transmission bandwidth is smaller than the bandwidth threshold, and the dynamic adjustment device 140A controls the register 120A and/or the data inserter 122A to decrease the number of the meaningless packets from 2 Mbps to 0 Mbps according to the transmission bandwidth.

In some embodiments of the present disclosure, when the dynamic adjustment device 140A determines that the transmission bandwidth is smaller than the bandwidth threshold, the register 120A and/or the data inserter 122A decreases the number of the meaningless packets, the multimedia processing device 110A simultaneously decreases the quality of the multimedia data. For example, if the transmission bandwidth is 5 Mbps, and the bandwidth threshold is 7 Mbps, the dynamic adjustment device 140A determines that the transmission bandwidth is smaller than the bandwidth threshold, the register 120A and/or the data inserter 122A decreases the number of the meaningless packets from 2 Mbps to 0 Mbps, and the multimedia processing device 110A simultaneously decreases quality of the multimedia data from 1080p to 720p.

In some embodiments of the present disclosure, when the dynamic adjustment device 140A determines that the transmission bandwidth is smaller than the bandwidth threshold, the register 120A and/or the data inserter 122A decreases the number of the meaningless packets, and the dynamic adjustment device 140A controls the multimedia processing device 110A to adjust the resolution, frame rate and/or bit rate of the multimedia data according to the transmission bandwidth. For example, if the transmission bandwidth is 5 Mbps, and the bandwidth threshold is 7 Mbps, the dynamic adjustment device 140A determines that the transmission bandwidth is smaller than the bandwidth threshold, and the register 120A and/or the data inserter 122A decreases the number of the meaningless packets from 2 Mbps to 0 Mbps, and the dynamic adjustment device 140A controls the multimedia processing device 110A to decrease the quality of the multimedia data from 1080p to 720p according to the transmission bandwidth.

FIG. 1B is a schematic diagram illustrating another multimedia data transmission system 100B according to some embodiments of the present disclosure. Comparing to the embodiment in FIG. 1A, in which the data inserter 122A is configured in the register 120A, the difference in FIG. 1B is that the data inserter 114B is configured in the multimedia processing device 110B. Furthermore, comparing to the embodiment in FIG. 1A, in which the dynamic adjustment device 140A is coupled to the multimedia processing device 110A, the internet transmission device 130A and the register 120A, in FIG. 1B, the dynamic adjustment device 140B is only coupled to the multimedia processing device 110B and the internet transmission device 130B. It should be noted that, the connection and the operation method of the reset of the device of the multimedia data transmission system 100B in FIG. 1B is similar to those of the multimedia data transmission system 100A in FIG. 1A, and will not be repeated herein.

It should be noted that, In some embodiments of the present disclosure, in the multimedia data transmission system 100B, the increasing and/or decreasing of the number of the meaningless packets is performed by the dynamic adjustment device 140B according to the transmission bandwidth to control the multimedia processing device 110B and/or the data inserter 114B to increase and/or decrease the number of the meaningless packets. In some other embodiments of the present disclosure, he increasing and/or decreasing of the number of the meaningless packets is performed by the multimedia processing device 110B and/or the data inserter 114B to increase and/or decrease the number of the meaningless packets.

FIG. 1C is a schematic diagram illustrating another multimedia data transmission system 100C according to some embodiments of the present disclosure. Comparing to the embodiment in FIG. 1B, in which the data inserter 114B is configured in the multimedia processing device 110B, the difference in FIG. 1C is that the data inserter 132C is configured in the internet transmission device 130C. It should be noted that, the connection and operation method of the reset of the devices of the multimedia data transmission system 100C in FIG. 1C are similar to those of the multimedia data transmission system 100B in FIG. 1B, and will not be repeated herein.

It should be noted that, In some embodiments of the present disclosure, in the multimedia data transmission system 100C, the increasing and/or decreasing of the number of the meaningless packets is performed by the dynamic adjustment device 140C according to the transmission bandwidth to control the internet transmission device 130C and/or the data inserter 132C to increase and/or decrease the number of the meaningless packets. In some other embodiments of the present disclosure, the increasing and/or decreasing of the number of the meaningless packets is performed by the internet transmission device 130C and/or the data inserter 132C to increase and/or decrease the number of the meaningless packets.

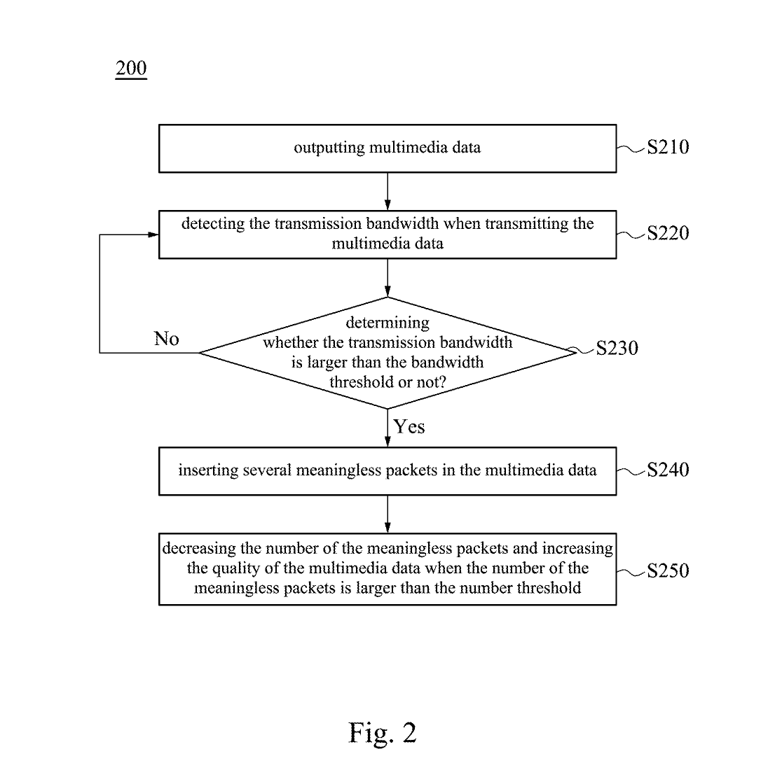

Reference is made to FIG. 2. FIG. 2 is a flow chart illustrating a multimedia data transmission method 200 according to some embodiments of the present disclosure. As illustrated in FIG. 2, the multimedia data transmission method 200 includes the following operations:

Operation S210: outputting multimedia data;

Operation S220: detecting the transmission bandwidth when transmitting the multimedia data;

Operation S230: determining whether the transmission bandwidth is larger than the bandwidth threshold or not;

Operation S240: inserting several meaningless packets in the multimedia data; and

Operation S250: decreasing the number of the meaningless packets and increasing the quality of the multimedia data when the number of the meaningless packets is larger than number threshold.

For ease of understanding the multimedia data transmission method 200, reference is made to FIG. 1A, FIG. 1B, FIG. 1C, and FIG. 2.

In operation S210, outputting the multimedia data. In some embodiments of the present disclosure, operation S210 may be performed by the multimedia processing device 110A, 110B, or 110C.

In some embodiments of the present disclosure, when outputting the multimedia data, the bandwidth threshold when transmitting the multimedia data is set. In some embodiments of the present disclosure, the bandwidth threshold is pre-set by the multimedia processing device 110A, 110B, or 110C. In some embodiments of the present disclosure, the bandwidth threshold is set by the dynamic adjustment device 140A, 140B, or 140C, or the bandwidth threshold is set by the user through the dynamic adjustment device 140A, 140B, or 140C and/or the multimedia processing device 110A, 110B, or 110C.

The above-mentioned bandwidth threshold is the bandwidth for playing the multimedia data fluently. For example, when the video display format of the multimedia data is 1080p, the multimedia processing device 110A set the bandwidth threshold to be 10M bit rate (10 Mbps), and when the video display format of the multimedia data is 720p, the multimedia processing device 110A set the bandwidth threshold to be 5M bit rate (5 Mbps). In response to different resolution, frame rate, and bit rate of the multimedia data, different bandwidth threshold may be set. The above-mentioned bandwidth threshold and video display format are for illustrative purposes only, and the present disclosure is not limited to this.

In operation S220, detecting the transmission bandwidth when transmitting the multimedia data. In some embodiments of the present disclosure operation, the operation S220 may be performed by the dynamic adjustment device 140A, 140B, or 140C. The above-mentioned transmission bandwidth may dynamically changes along with time, hardware device, and/or usage behavior of other users.

In operation S230, determining whether the transmission bandwidth is larger than the bandwidth threshold or not. In some embodiments of the present disclosure operation, the operation S230 may be performed by the dynamic adjustment device 140A, 140B, or 140C. For example, if the transmission bandwidth is 6 Mbps, and the bandwidth threshold is 5 Mbps, it is determined that the transmission bandwidth is larger than the bandwidth threshold. If the transmission bandwidth is 5 Mbps, and the bandwidth threshold is 6 Mbps, it is determined that the transmission bandwidth is not larger than the bandwidth threshold.

As illustrated in FIG. 2, in some embodiments of the present disclosure, if the determination result of operation S230 is that the transmission bandwidth is larger than the bandwidth threshold, operation S240 is performed. If the determination result of operation S230 is that the transmission bandwidth is not larger than the bandwidth threshold, operation S220 is performed continually.

In operation S240, insert several meaningless packets in the multimedia data. In some embodiments of the present disclosure, operation S240 may be performed by the data inserter 122A, 114B, or 132C. In some other embodiments of the present disclosure, operation S240 may be performed by the register 120A, the multimedia processing device 110B, or the internet transmission device 130C. For example, if the transmission bandwidth is 6 Mbps, and the bandwidth threshold is 5 Mbps, in operation S230, it is determined that the transmission bandwidth is larger than bandwidth threshold, then in operation S240, insert several meaningless packets in the multimedia data. The above-mentioned number of the meaningless packets may be for example 1 Mbps.

In operation S250, when the number of the meaningless packets is larger than the number threshold, decreasing the number of the meaningless packets and increasing the quality of the multimedia data. In some embodiments of the present disclosure, operation S250 may be performed by the data inserter 122A, 114B, or 132C. In some other embodiments of the present disclosure, operation S440 may be performed by the register 120A, the multimedia processing device 110, or the internet transmission device 130C.

For example, if the number threshold is 5 Mbps, when the number of the meaningless packets is larger than 5 Mbps, in operation S250, the number of the meaningless packets decreases from 5 Mbps to 0 Mbps, and the multimedia data is adjusted from 720p to 1080p.

In some embodiments of the present disclosure, operation S250 includes increasing at least one of a resolution, a frame rate and a bit rate of the multimedia data. For example, when the number of the meaningless packets is larger than number threshold, the quality of the multimedia data may be increased by increasing at least one of the resolution, frame rate, and bit rate of the multimedia data by the multimedia processing device 110A, 110B, or 110C.

In some embodiments of the present disclosure operation, operation S250 includes increasing the bandwidth threshold. For example, if the number threshold is 5 Mbps, when the number of the meaningless packets is larger than 5 Mbps, in operation S250, the number of the meaningless packets is decreased from 5 Mbps to 0 Mbps, the multimedia data is adjusted from 720p to 1080p, and the bandwidth threshold is increased from 5 Mbps to 10 Mbps.

In some embodiments of the present disclosure, the transmitted multimedia data is increased sequentially. For example, according to the number of the meaningless packets, sequentially increase the transmitted multimedia data from 5 Mbps to 6 Mbps, then from 6 Mbps to 7 Mbps, to ensure the multimedia data being played fluently.

In some embodiments of the present disclosure operation, operation S250 includes increasing the bandwidth threshold, and the increment of the bandwidth threshold is the same as the decrement of the meaningless packet. For example, if the number threshold is 5 Mbps, when the number of the meaningless packets is larger than 5 Mbps, in operation S250, the number of the meaningless packets is decreased from 5 Mbps to 0 Mbps, the multimedia data is adjusted from 720p to 1080p, and the bandwidth threshold is increased from 5 Mbps to 10 Mbps. That is, the increment of the bandwidth threshold is the same as the decrement of the meaningless packets.

The above-mentioned meaningless packets may be blank packets, wrong packets and/or undefined packets.

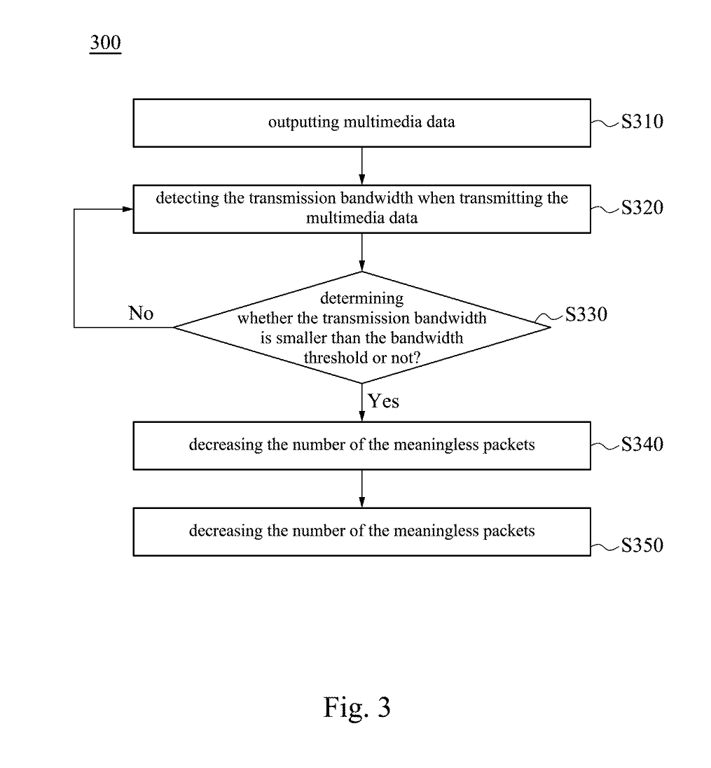

Reference is made to FIG. 3. FIG. 3 is a flow chart illustrating another multimedia data transmission method 300 according to some embodiments of the present disclosure. As illustrated in FIG. 3, multimedia data transmission method 300 includes the following operation:

Operation S310: outputting multimedia data;

Operation S320: detecting the transmission bandwidth when transmitting the multimedia data;

Operation S330: determining whether the transmission bandwidth is smaller than the bandwidth threshold or not;

Operation S340: decreasing the number of the meaningless packets; and

Operation S350: decreasing the quality of the multimedia data.

For ease of understanding the multimedia data transmission method 300, reference is made to FIG. 1A, FIG. 1B, FIG. 1C, and FIG. 3.

In operation S310, outputting multimedia data. In some embodiments of the present disclosure, operation S310 may be performed by the multimedia processing device 110A, 110B, or 110C. In some embodiments of the present disclosure, the above-mentioned outputted multimedia data includes several data packets, and the data packets include several meaningless packets. The above-mentioned meaningless packets may be blank packets, wrong packets and/or undefined packets.

In some embodiments of the present disclosure, when outputting the multimedia data, the bandwidth threshold when transmitting the multimedia data is set. The above-mentioned method of setting the bandwidth threshold when transmitting the multimedia data in operation S310 is the same as operation S210, and will not be repeated herein.

In operation S320, detecting the transmission bandwidth when transmitting the multimedia data. In some embodiments of the present disclosure, operation S320 may be performed by the dynamic adjustment device 140A, 140B, or 140C. Operation S320 is the same as operation S310, and will not be repeated herein.

In operation S330, determining whether the transmission bandwidth is smaller than the bandwidth threshold or not. In some embodiments of the present disclosure, operation S330 may be performed by the dynamic adjustment device 140A, 140B, or 140C. For example, when the transmission bandwidth is 6 Mbps, and the bandwidth threshold is 5 Mbps, it is determined that the transmission bandwidth is not smaller than the bandwidth threshold. If the transmission bandwidth is 5 Mbps, and the bandwidth threshold is 6 Mbps, it is determined that the transmission bandwidth is smaller than the bandwidth threshold.

As illustrated in FIG. 3, in some embodiments of the present disclosure, if the determination result of operation S330 is that the transmission bandwidth is smaller than the bandwidth threshold, operation S340 is performed. If the determination result of operation S330 is that the transmission bandwidth is not smaller than bandwidth threshold, operation S320 is performed.

In operation S340, decreasing the number of the meaningless packets. In some embodiments of the present disclosure, operation S340 may be performed by the data inserter 122A, 114B, or 132C. In some other embodiments of the present disclosure, operation S440 may be performed by the register 120A, the multimedia processing device 110, or the internet transmission device 130C.

For example, if the transmission bandwidth is 8 Mbps, and the bandwidth threshold is 10 Mbps, in operation S330, it is determined that the transmission bandwidth is smaller than the bandwidth threshold, in operation S340, the number of the meaningless packets is decreased. For example, decreasing the number of the meaningless packets from 2 Mbps to 0 Mbps.

In operation S350, decreasing the quality of the multimedia data. In some embodiments of the present disclosure operation, S350 may be performed by the multimedia processing device 110A, 110B, or 110C. In some embodiments of the present disclosure, operation S350 may be performed by the multimedia compressor 112A, 112B, or 112C.

For example, if the transmission bandwidth is 5 Mbps, and the bandwidth threshold is 7 Mbps, in operation S330, it is determined that the transmission bandwidth is smaller than the bandwidth threshold, in operation S350, the quality of the multimedia data is decreased from 1080p to 720p.

In some embodiments of the present disclosure, operation S350 includes decreasing the resolution, frame rate and/or bit rate of the multimedia data.

In some embodiments of the present disclosure, operation S340 and operation S350 may be performed simultaneously. For example, if the transmission bandwidth is 5 Mbps, and the bandwidth threshold is 7 Mbps, in operation S330, it is determined that the transmission bandwidth is smaller than the bandwidth threshold, the number of the meaningless packets is decreased from 2 Mbps to 0 Mbps, and the quality of the multimedia data is decreased from 1080p to 720p.

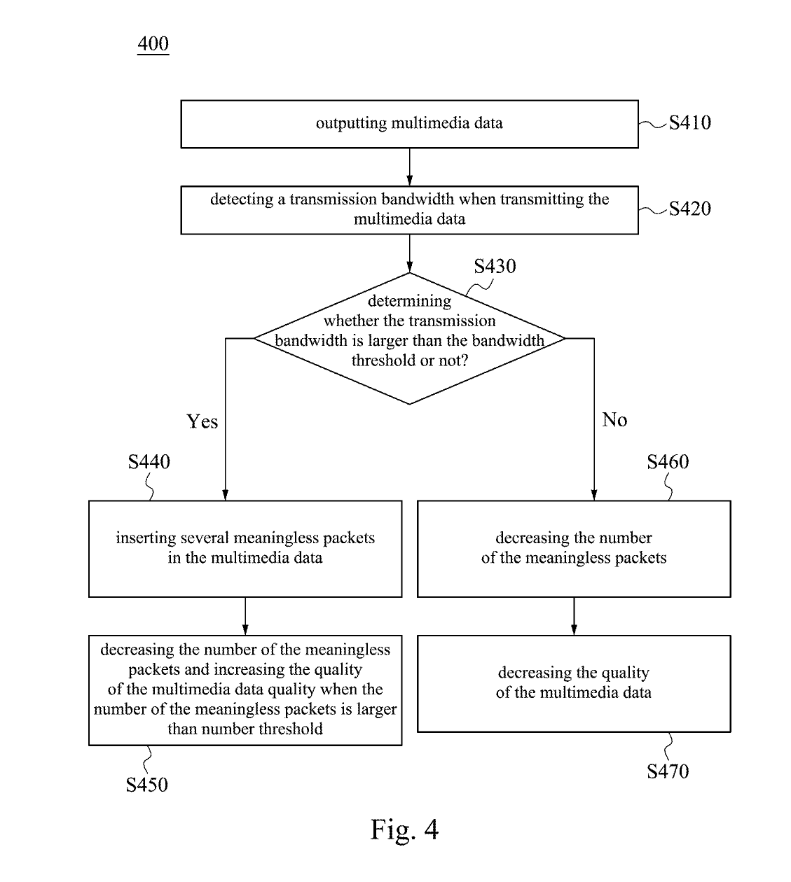

Reference is made to FIG. 4. FIG. 4 is a flow chart illustrating another multimedia data transmission method according to some embodiments of the present disclosure. As illustrated in FIG. 4, multimedia data transmission method 400 includes the following operation:

Operation S410: outputting multimedia data;

Operation S420: detecting a transmission bandwidth when transmitting the multimedia data;

Operation S430: determining whether the transmission bandwidth is larger than the bandwidth threshold or not;

Operation S440: inserting several meaningless packets in the multimedia data;

Operation S450: decreasing the number of the meaningless packets and increasing the quality of the multimedia data quality when the number of the meaningless packets is larger than number threshold;

Operation S460: decreasing the number of the meaningless packets; and

Operation S470: decreasing the quality of the multimedia data.

For ease of understanding the multimedia data transmission method 400, reference is made to FIG. 1A, FIG. 1B, FIG. 1C, and FIG. 4.

In operation S410, outputting multimedia data. In some embodiments of the present disclosure, operation S410 may be performed by the multimedia processing device 110A, 110B, or 110C. The detailed implementation method of operation S410 is the same as operation S310 and operation S210, and will not be repeated herein.

In operation S420, detecting a transmission bandwidth when transmitting the multimedia data. In some embodiments of the present disclosure, operation S420 may be performed by the dynamic adjustment device 140A, 140B, or 140C. The detailed implementation method of the operation S420 is the same as operation S320 and operation S220, and will not be repeated herein.

In operation S430, determining whether the transmission bandwidth is larger than bandwidth threshold or not. In some embodiments of the present disclosure, operation S430 may be performed by the dynamic adjustment device 140A, 140B, or 140C. The detailed implementation method of operation S430 is the same as the operation S330, and will not be repeated herein.

As illustrated in FIG. 4, in some embodiments of the present disclosure, if the determination result of the operation S430 is that the transmission bandwidth is larger than the bandwidth threshold, operation S440 is performed. If the determination result of the operation S430 is that the transmission bandwidth is not larger than the bandwidth threshold, operation S460 is performed.

In operation S440, inserting several meaningless packets in the multimedia data. In some embodiments of the present disclosure, operation S440 may be performed by the data inserter 122A, 114B, or 132C. In some other embodiments of the present disclosure, operation S440 may be performed by the register 120A, the multimedia processing device 110B, or the internet transmission device 130C. The detailed implementation method of the above-mentioned operation S440 is the same as operation S240, and will not be repeated herein.

In operation S450, when number of the meaningless packets is larger than number threshold, decreases number of the meaningless packets. In some embodiments of the present disclosure, operation S450 may be performed by the data inserter 122A, 114B, or 132C to decrease the number of the meaningless packets, and the quality of the multimedia data is increased by the multimedia processing device 110A, 110B, or 110C. The detailed implementation method of the above-mentioned operation S450 is the same as operation S250, and will not be repeated herein.

In operation S460, decreasing the number of the meaningless packets. In some embodiments of the present disclosure, operation S460 may be performed by the data inserter 122A, 114B, or 132C. In some embodiments of the present disclosure, operation S460 may be performed by the register 120A, the multimedia processing device 110B, or the internet transmission device 130C. The detailed implementation method of the above-mentioned operation S460 is the same as operation S340, and will not be repeated herein.

In operation S470, decreasing the quality of the multimedia data. In some embodiments of the present disclosure, operation S470 may be performed by the multimedia processing device 110A, 110B, or 110C. In some embodiments of the present disclosure, operation S470 may be performed by the multimedia compressor 112A, 112B, or 112C. The detailed implementation method of the above-mentioned operation S470 is the same as operation S350, and will not be repeated herein.

The above-mentioned transmission bandwidth, bandwidth threshold, number threshold, number of the meaningless packets, increment/decrement of the meaningless packets and video display format are for illustrative purposes only, and the present disclosure is not limited to this.

In some embodiments of the present disclosure, the multimedia processing device 110A, the multimedia processing device 110B, and the multimedia processing device 110C may be devices or circuits with the function of outputting multimedia data and/or processing multimedia data or other equivalent functions. In some embodiments of the present disclosure, the register 120A, the register 120B, and the register 120C may be devices or circuits with the function of temporarily storing multimedia data or other equivalent functions. In some embodiments of the present disclosure, the internet transmission device 130A, the internet transmission device 130B, and the internet transmission device 130C may be devices or circuits with the function of transmitting multimedia data to the client side and/or the server side or other equivalent functions.

In some embodiments of the present disclosure, the dynamic adjustment device 140A, the dynamic adjustment device 140B, and the dynamic adjustment device 140C may be servers, circuits, central processor units, MCUs or other devices with the function of detecting, storage, computing, data reading, signals or messages receiving, signals or messages sending, and other equivalent functions.

In some embodiments of the present disclosure, the multimedia compressor 112A, the multimedia compressor 112B, and the multimedia compressor 112C may be devices or circuits with the function of adjusting the resolution, frame rate, and/or bit rate of the multimedia data or other equivalent functions. In some embodiments of the present disclosure, the data inserter 122A, the data inserter 114B, and the data inserter 132C may be devices or circuits with the function of inserting or decreasing packets from the multimedia data or other equivalent functions.

According to the embodiment of the present disclosure, it is understood that the embodiment of the present disclosure is to provide a multimedia data transmission system and a multimedia data transmission method, and in particular, a multimedia data transmission system and a multimedia data transmission method for dynamically adjusting a transmission amount of multimedia data in response to transmission bandwidth., so as to effectively avoid multimedia data being discarded due to the lack of bandwidth, and in the case of sufficient bandwidth, the original compressed multimedia data may be gradually restored to the original set value. In this way, the most appropriate multimedia data transfer capacity may be adjusted in accordance with changes in network bandwidth without affecting the audio and video multimedia data playing fluency.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A multimedia data transmission method, comprising:
outputting multimedia data;
detecting a transmission bandwidth when transmitting the multimedia data;
determining whether the transmission bandwidth is larger than a bandwidth threshold or not;
inserting a plurality of meaningless packets in the multimedia data if the transmission bandwidth is larger than the bandwidth threshold; and
decreasing a number of the meaningless packets and increasing a quality of the multimedia data if the number of the meaningless packets is larger than a number threshold.

2. The multimedia data transmission method of claim 1, wherein increasing the quality of the multimedia data comprises:
increasing at least one of a resolution, a frame rate, and a bit rate of the multimedia data.

3. The multimedia data transmission method of claim 1, wherein decreasing the number of the meaningless packets and increasing the quality of the multimedia data comprises:
increasing the bandwidth threshold.

4. The multimedia data transmission method of claim 3, wherein increasing the bandwidth threshold comprises:
an increment of the bandwidth threshold is equal to a decrement of the meaningless packet.

5. The multimedia data transmission method of claim 1, wherein the meaningless packets comprises:
a plurality of blank packets, a plurality of wrong packets, and/or a plurality of undefined packets.

6. A multimedia data transmission system, comprising:
a multimedia processing device, configured to output multimedia data;
a register, coupled to the multimedia processing device, wherein the register is configured to temporarily store a plurality of data packets of the multimedia data;
an internet transmission device, coupled to the register, wherein the internet transmission device is configured to transmit the data packets; and
a dynamic adjustment device, configured to detect a transmission bandwidth of the internet transmission device, and configured to determine whether the transmission bandwidth is larger than a bandwidth threshold or not;
wherein when the dynamic adjustment device determines the transmission bandwidth is larger than the bandwidth threshold, at least one of the multimedia processing device, the register, and the internet transmission device inserts a plurality of meaningless packets in the multimedia data, and if the number of the meaningless packets is larger than a number threshold, at least one of the multimedia processing device, the register, and the internet transmission device decreases the number of the meaningless packets, and the multimedia processing device increases a quality of the multimedia data.

7. The multimedia data transmission system of claim 6, wherein the multimedia processing device increases the quality of the multimedia data by increasing at least one of a resolution, a frame rate, and a bit rate of the multimedia data.

8. The multimedia data transmission system of claim 7, wherein the dynamic adjustment device is further configured to control the multimedia processing device to adjust the resolution, the frame rate, and/or the bit rate of the multimedia data according to the transmission bandwidth.

9. The multimedia data transmission system of claim 6, wherein when the multimedia processing device increases the quality of the multimedia data, the dynamic adjustment device, and/or the multimedia processing device increases the bandwidth threshold.

10. The multimedia data transmission system of claim 9, wherein when the dynamic adjustment device increases the bandwidth threshold, an increment of the bandwidth threshold is equal to a decrement of the meaningless packets.

11. The multimedia data transmission system of claim 6, wherein the dynamic adjustment device is further configured to control at least one of the multimedia processing device, the register, and the internet transmission device to adjust a number of the meaningless packets according to the transmission bandwidth.

12. A multimedia data transmission method, comprising:
outputting multimedia data, wherein the multimedia data comprises a plurality of data packets, and the data packets comprises a plurality of meaningless packet;
detecting a transmission bandwidth when transmitting the multimedia data;
determining whether the transmission bandwidth is smaller than a bandwidth threshold or not; and
decreasing the number of the meaningless packets if the transmission bandwidth is smaller than the bandwidth threshold.

13. The multimedia data transmission method of claim 12, further comprising:
decreasing a quality of the multimedia data.

14. The multimedia data transmission method of claim 13, further comprising:
decreasing the number of the meaningless packets and decreasing the quality of the multimedia data simultaneously if the transmission bandwidth is smaller than the bandwidth threshold.

15. The multimedia data transmission method of claim 13, wherein decreasing the quality of the multimedia data comprises:
decreasing a resolution, a frame rate, and/or a bit rate of the multimedia data.

16. The multimedia data transmission method of claim 12, wherein the meaningless packets comprises:
a plurality of blank packets, a plurality of wrong packets, and/or a plurality of undefined packets.

17. A multimedia data transmission system, comprising:
a multimedia processing device, configured to output multimedia data, wherein the multimedia data comprises a plurality of data packets, and the data packets comprises a plurality of meaningless packet;
a register, coupled to the multimedia processing device, wherein the register temporarily stores the data packets of the multimedia data;
an internet transmission device, coupled to the register, wherein the internet transmission device is configured to transmit the data packets; and
a dynamic adjustment device, configured to detect a transmission bandwidth of the internet transmission device, and determine whether the transmission bandwidth is smaller than a bandwidth threshold or not;
wherein when the dynamic adjustment device determines the transmission bandwidth is smaller than the bandwidth threshold, at least one of the multimedia processing device, the register and the internet transmission device decreases the number of the meaningless packets.

18. The multimedia data transmission system of claim 17, wherein the multimedia processing device is further configured to decrease the quality of the multimedia data.

19. The multimedia data transmission system of claim 18, wherein when decreasing the number of the meaningless packets, the multimedia processing device simultaneously decreases the quality of the multimedia data.

20. The multimedia data transmission system of claim 19, wherein the dynamic adjustment device is further configured to control the multimedia processing device to adjust a resolution, a frame rate, and/or a bit rate of the multimedia data according to the transmission bandwidth.

21. The multimedia data transmission system of claim 17, wherein the dynamic adjustment device is further configured to control at least one of the multimedia processing device, the register, and the internet transmission device to decrease a number of the meaningless packets according to the transmission bandwidth.
